(19) United States
(12) Patent Application Publication
(10) Pub. No.: US 2012/0060443 A1
(43) Pub. Date: Mar. 15, 2012

(54) DECK FRAME CHANNEL BEAM

(75) Inventors: Shaun Jeffrey Vernon, Elizabeth, CO (US); Douglas Brian Lind, Littleton, CO (US)

(73) Assignee: Iron Deck Corp., Castle Rock, CO (US)

(21) Appl. No.: 13/046,390

(22) Filed: Mar. 11, 2011

Related U.S. Application Data
(60) Provisional application No. 61/382,025, filed on Sep. 12, 2010.

(51) Int. Cl. E04C 3/07; B21B 45/00; B23P 25/00; E04C 3/29

(52) U.S. Cl. 52/834; 52/846; 72/46; 29/458

(57) ABSTRACT

A channel beam used in building construction of sub-decks is described. The channel beam essentially formed from a steel sheet that is bent in a C-shaped cross-section possessing a web having bends, thus forming an upper flange and a lower flange. The channel beam extending in length along the C-shaped cross-section. A ceramic coating essentially encapsulates the channel beam whereby the sheet metal of the channel beam is essentially encapsulated by the ceramic coating prior to being bent in the C-shaped cross-section.

### CROSS-REFERENCE TO RELATED APPLICATIONS

This application is a non-provisional application of provisional U.S. Ser. No. 61/382,025, entitled DECK FRAME, filed Sep. 12, 2010, as to which this application claims benefit of priority and the subject matter of which is incorporated herein by reference.

### BACKGROUND OF THE INVENTION

1. Field of the Invention

The present invention relates generally to using cold rolled steel formed beams for sub-deck fabrication.

2. Description of Related Art

Sub-deck constructed from wooden beams is a standard way of building frames for surface flooring and decks. Though wooden beams are relatively easy to work with, decomposition due to weather and time generally only permit between 10 and 20 years of life span before falling apart. This has been, somewhat, improved with the introduction of pressure treated wood lumber, which is a formaldehyde-based impregnated wood. It is to innovations related to the longevity of sub-decks that the claimed invention is generally directed.

### SUMMARY OF THE INVENTION

The present invention relates generally to a novel deck frame configuration for building construction of sub-decks, which overcomes the disadvantages and limitations of the present state of the art through advantageous arrangements of ceramic-based coated channel beams. The present invention also relates to methods of fabrication and utilization of such ceramic-based coated channel beams as well as to building and employing such ceramic-based coated channel beams.

One embodiment of the present invention can therefore comprise a channel beam comprising: steel sheet metal that is bent in a C-shaped cross-section possessing a web with bends forming an upper flange and a lower flange, the channel beam extending in length along the C-shaped cross-section; a ceramic coating essentially encapsulating the channel beam wherein the sheet metal is essentially encapsulated by the ceramic coating prior to being bent in the C-shaped cross-section; the sheet metal is between 14 gage and 18 gage steel.

Yet another embodiment of the present invention can therefore comprise a channel beam constructed by a method comprising: providing steel sheet metal possessing a length, a width, and a thickness, wherein the length is dimensionally greater than the width, the width is dimensionally greater than the thickness, the width and the thickness define a plane wherein a cross-section of the sheet metal resides, the thickness is between 14 gage and 18 gage steel; applying a ceramic coating on the sheet metal to essentially encapsulate the steel sheet metal; bending the sheet metal after the applying step into a first flange, a second flange, and a web, to form a C-shaped cross-section in the plane, the first flange and the second flange terminate at the edges of the C-shaped cross-section, after the bending step, the sheet metal remains essentially encapsulated by the ceramic coating.

### BRIEF DESCRIPTION OF THE DRAWINGS

FIG. 1 is an illustration of a deck arrangement consistent with an embodiment of the present invention.

FIGS. 2A-2B are diagrammatic illustrations of C-shaped channel beam deck ledger consistent with embodiments of the present invention.

FIGS. 3A-3B are diagrammatic illustrations of U-shaped channel beam deck joist consistent with embodiments of the present invention.

FIGS. 4A-4D are diagrammatic illustrations of a box-beam consistent with embodiments of the present invention.

FIG. 5 is a side view illustration of an embodiment of deck planks attached to a deck ledger consistent with embodiments of the present invention.

### DETAILED DESCRIPTION

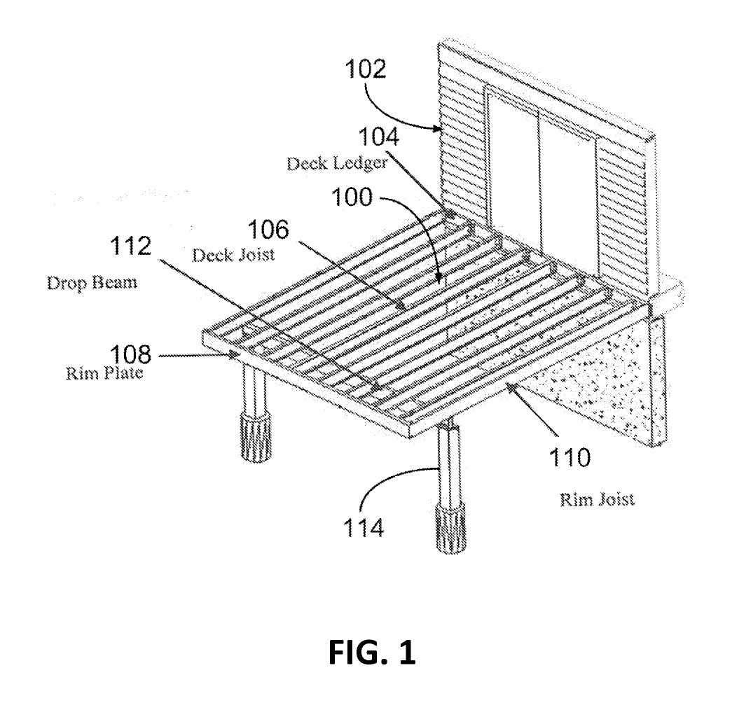

Referring to the drawings in general, and more specifically to FIG. 1, shown therein is an illustration of an embodiment of a deck frame assembly 100 attached to an external house wall 102. Other embodiments contemplate the deck frame assembly 100 extending from other kinds of structures such as commercial buildings, sheds, etc. Optionally, the deck frame assembly 100 can stand alone as a free standing deck or platform, for example.

In certain embodiments, the deck frame assembly 100 is generally comprised of a deck ledger 104 adapted to be fixedly attached to an external building wall, such as the house wall 102. The deck ledger 104 can be fixedly attached to the house wall 102 via a plurality of screws, pins, nails, etc., just to name several illustrative elements used for attaching known to those skilled in the art. As illustratively shown, extending from the deck ledger 104 is a plurality of deck joists 106, which in some embodiments are steel channel beams, that are essentially evenly spaced apart, such as in increments of 18 inches, for example. Other types of metal used to compose the beams are contemplated. In another embodiment, the deck joists 106 can be spaced at non-constant intervals, i.e., random spacing or, optionally, spacing alternating spacing, such as 12 inches, 20 inches, 12 inches, etc. In the illustrative embodiment, the deck joists 106 terminate into a rim plate 108 that is essentially perpendicular to the deck joists 106 and parallel to the deck ledger 104. The deck joists 106 can e attached to the rim plate 104 or the deck ledger 106 via hanging brackets, for example. In optional embodiments, the deck ledger 104 and rim plate 108 are not parallel to one another and the deck joists 106 are not perpendicular to either the deck ledger 104 or the rim plate 108 or both the deck ledger 104 and rim plate 108. As illustratively shown in the present embodiment, essentially parallel and in plane to the deck joists 106 are two rim joists 110. The deck joists 106 are interposed between the rim joists 110 in order to provide both an aesthetically finished look and enhanced structural integrity to the deck frame assembly 100. The deck ledger 104 is arranged to support the deck joists 106 and rim joists 110 at one end of the deck frame assembly 100 and one drop beam 112 supports the deck joists 106 and rim joists 110 at a location along the length of the deck joists 106 and rim joists 110. In this example, the drop beam 112 is supporting the deck frame assembly 100 near the distal end of the deck joists 106 and rim joists 110. The drop beam 112 is supported by two caissons 114 in the present illustrative embodiment, however, conceivably multiple caissons 114 can be used. Optionally, the drop beam 112 can be supported by a number of different structures, including, but not limited to a wall structure or structures, block structures, a platform, etc. In optional embodiments, multiple drop beams 112 can be used along the length of the deck joists 106 and rim joists 110. In the embodiment of FIG. 1, the deck ledger 104 is a C-shaped channel beam, the deck joist 106 is a U-shaped channel beam, the rim plate 108 is a C-shaped channel beam, the rim joist 110 is a U-shaped channel beam, the drop beam 112 is a box-beam that is essentially comprised of a U-shaped channel beam disposed in the channel of a C-shaped channel beam.

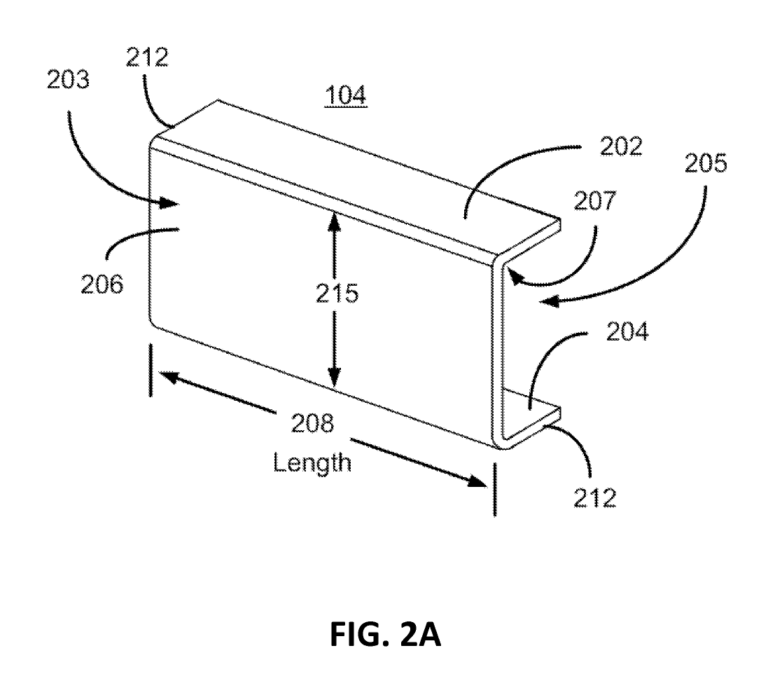

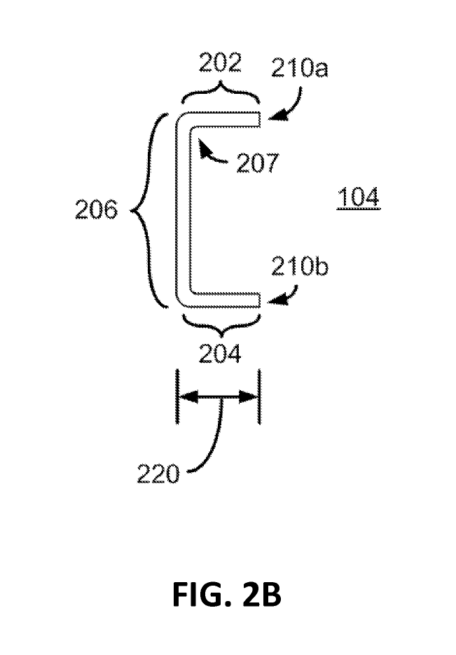

FIGS. 2A-2B are illustrations of the deck ledger 104, consistent with certain embodiments of the present invention. In the present embodiment, the deck ledger 104 is one embodiment of a channel beam with a C-shaped cross-section that will be discussed in detail and by way of example. With respect to FIG. 2A, shown therein is perspective segment of the deck ledger 104. As illustratively shown, the deck ledger 104 possesses an upper flange 202, a web 206 (having a web height 215) and a lower flange 204, together forming the “C” cross-sectional shape, referred to herein as a C-shaped cross-section, also referred to herein as a C-shaped profile. The C-shaped profile creates a channel 205 that runs along the length 208 of the deck ledger 104. For purposes of orientation, the channel 205 portion will be hereinafter designated as the front of the deck ledger 104, corresponding to the channel side, and the opposite side of the flat web 206 portion will be designated the back side 203 of the deck ledger 104.

FIG. 2B is a cross-section view of the C-shaped channel beam 104. As illustratively shown, the web 206, the upper flange 202 and the lower flange 204 are essentially flat. The flanges 202 and 204 are formed from bends 207 after the steel sheet metal is essentially encased in the ceramic-based coating. By essentially encased, the channel beam 104 may be encased on all surfaces with the exception of the ends 212 of the channel beam 104 defined as the terminal edges along the length 208 and the ends 210a and 210b of the flanges 202 and 204, respectively. In other embodiments, the ceramic-based coating essentially covers the ends 210a and 210b of the flanges 202 and 204, respectively. In one preferred embodiment, the flanges 202 and 204 have a flange length 220 that extend 2 inches from the web 206 in the cross-sectional plane. In optional embodiments, the flanges 202 and 204 possess a flange length 220 that extend 1⅝ inches from the web 206 in the cross-sectional plane.

In certain embodiments, the deck ledger 104 is cold formed from 14 gage pre-galvanized painted steel sheets and the deck joists 106 and rim joists 110 are cold formed from 18 gage pre-galvanized painted steel sheets, however, certain optional embodiments contemplate any combination between 12 and 18 gage steel sheet metal that is not necessarily galvanized. In more detail, prior to forming the deck ledger 104, deck joists 106 and rim joists 110, a flat roll of galvanized steel (essentially a steel sheet roll) is primed on both sides with a primer followed by being coated on both sides with a ceramic-based coating that is heat cured. In certain embodiments, the radius of the inner bends 207 is preferably between 0.125 inches to 0.25 inches, preferably the radius of the outer bends is between 0.25 and 0.5 inches. In certain embodiments, the flat, unrolled, sheet width for the deck ledger 104 is different from the sheet width for the deck joist 106, for example, the metal rolls can be 42-68 inches wide depending on whether the metal sheet is for a deck joist 106 or a deck ledger 104, for example. In an optional embodiment, the widths can be essentially the same. The coated, or painted, steel sheets are then cut to size and cold rolled to form the “C” and “U” profiles of the deck ledger 104, deck joists 106 and rim joists 110.

More specifically, channel beam construction embodiments using ceramic based coatings are contemplated via a method described below. It should be recognized that the steps presented in the described embodiments of the present invention do not necessarily require any particular sequence unless otherwise stated. In certain embodiments, rolls of steel sheet metal having a thickness of between 12 gage to 18 gage is galvanized. One commercial example is a G60 galvanized steel roll that can be upwards of 3,000 linear feet of sheet metal between 42 inches and 68 inches in width, such as that produced by Wheeling Nissan Steel Mill of Follansbee, W.V.

With regards to coating the rolls of sheet metal, one commercial embodiment is performed by Centria Coating Service, Head Quartered in Pittsburg, Pa. Here, a roll of galvanized steel sheet metal is threaded in a machine that applies and cures both a primer and ceramic-based paint in a continuous process. After cleaning the sheet metal to remove undesirable contamination such as oils, for example, the sheet metal is primed using a polyester primer (that is compatible with the ceramic-based paint) in a continuous roller process whereby the primer is rolled onto the top and bottom surfaces of the sheet metal. The primed sheet metal is then cured in long ovens at between 435° F. and 450° F. during a continuous feed process. The cured primed sheet metal is then coated with a ceramic-based paint on both the top and bottom surfaces of the sheet metal with rollers and then cured in the same ovens at 435° F. and 450° F. in the same continuous feed process. One example of a ceramic-based paint is a class of polyester paints modified with ceramic, such as the Brown-Texture paint line manufactured by Duracoat Head Quartered in Riverside, Calif. Optionally, the sheet metal can be coated by brush, sponge, baths, spray, and other techniques know to those skilled in the art. In certain embodiments, a ceramic coating may have a ceramic concentration that is greater than 20% by weight, preferably greater than 50%, even more preferably greater than 60%, and even more preferably greater than 70%, but ceramic concentrations at 80% and in excess of 90% are contemplated. Ceramics in the ceramic coating include, but are not limited to, silica, titanium-dioxide, alumina, just to name a few examples. The sheets of metal are then cut into rolls between 10 inches and 15 inches wide.

With regards to forming the final channel shape, embodiments of the present invention contemplate forming the sheet metal through a cold-rolling process. Here, the metal sheets are bent in a cold-rolling process that, in one embodiment, employs rollers that bend the metal sheets progressively and gradually into their final channel shape with the specified bend radii, or bend angles. This process can be commercially practiced by Iron Deck Corporation of 4935 Newport St., Commerce City, Colo. 80022, whereby the rolls of ceramic-based coated sheet metal are loaded into an uncoiler machine and the coated metal sheets are fed through an 11-stand roll former where they are bent into shape and sheared to desired lengths, such as 20 foot beams, for example. The ceramic-based coating remains essentially completely adhered to the sheet metal after the channel beams are finished being formed.

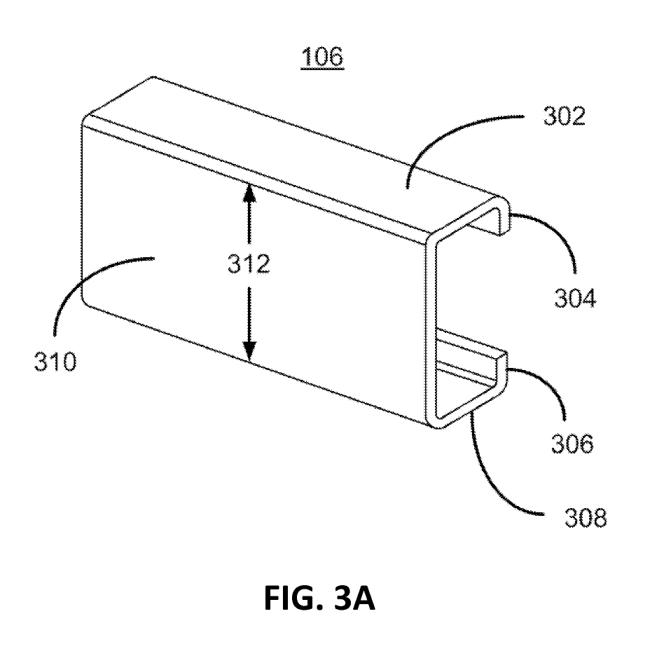

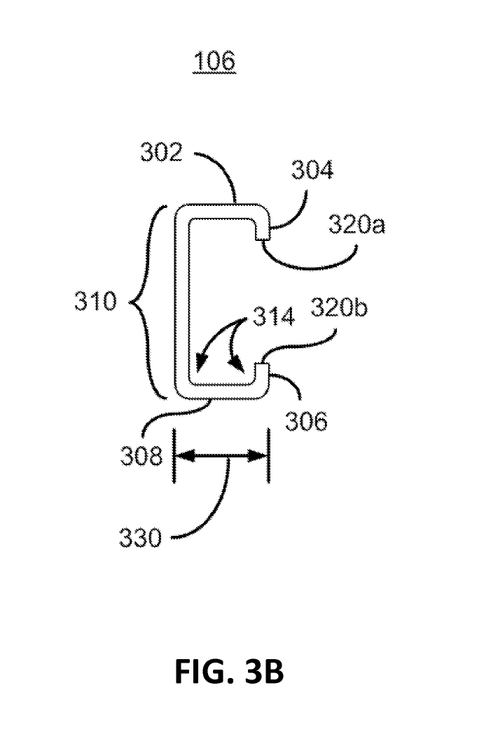

FIG. 3A is an embodiment of a deck joist 106 consistent with embodiments of the present invention. The deck joist 106, an embodiment of a U-shaped channel beam, has a web 310 and web height 312. The deck joist 106 has an upper flange 302, a lower flange 308, an upper return 304 and a lower return 306, thus forming a “U” shaped profile. The bends 314 are consistent with the bends 207 described in conjunction with FIG. 2B. Furthermore, the U-shaped channel beam is manufactured similarly to the C-shaped channel beam described in conjunction with FIGS. 2A and 2B.

FIG. 3B is a cross-section view of the U-shaped channel beam 106 (also known as a U-shaped channel track). As illustratively shown, the web 310, the upper flange 302 and the lower flange 308 are essentially flat. The flanges 302 and 308 are formed from bends 314 after the steel sheet metal comprising the U-shaped channel beam 106 is essentially encased in the ceramic-based coating. The U-shaped channel beam 106 has an upper return 304 and a lower return 306 such that the ends of the returns 320a and 320b (i.e. the terminal edges of the returns) face one another as shown. In one preferred embodiment, the flanges 302 and 308 each have a flange length 330 that preferably extends 1½ inches and more preferably extends 1¼ inches from the web 310 in the cross-sectional plane. In optional embodiments, the flanges 202 and 204 have a flange length 330 that extend 1⅝ inches from the web 206 in the cross-sectional plane.

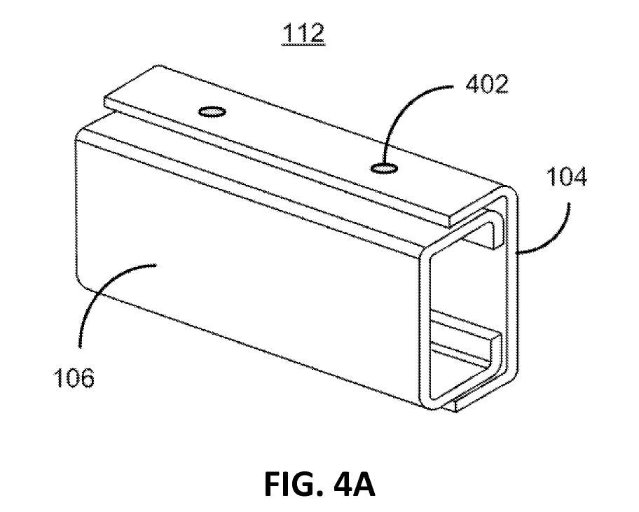

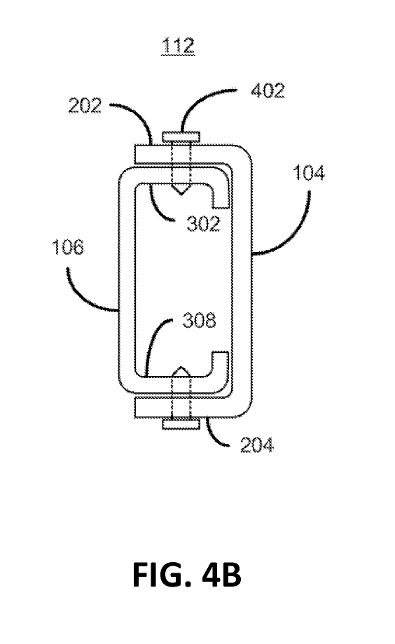

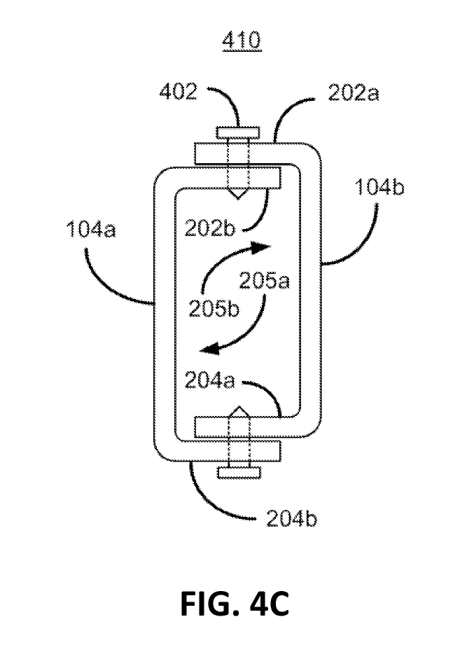

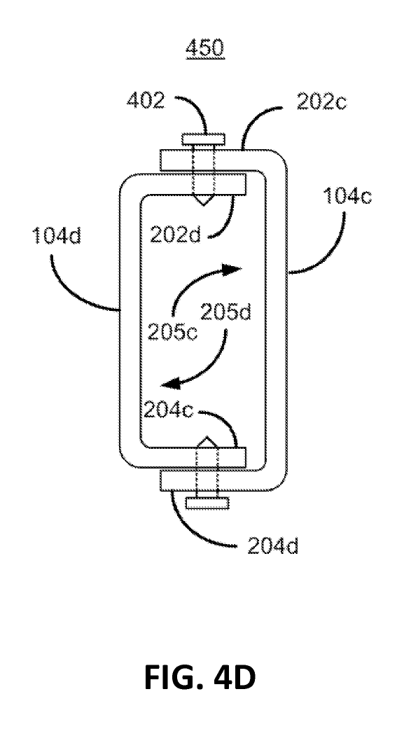

FIG. 4A is an embodiment of a box beam 112 that is comprised of a C-shaped channel beam 104 that at least partially receives a U-shaped channel beam 106. The U-shaped channel beam 106 being at least partially disposed in the channel 105 of the C-shaped channel beam 104, as shown. The C-shaped channel beam 104 and the U-shaped channel beam 106 are fixedly attached by attachment members 402, such as by screws, nails or ballistic nails, for example.

FIG. 4B is a cross-section view of the box beam 112 embodiment of FIG. 4A. As illustratively shown, the U-shaped channel beam 106 is disposed in the C-shaped channel beam 104 and fixedly attached together at the upper flanges 302 and 202 and at the lower flanges 308 and 204 by attachment members 402. The cross-section essentially creating a hollow square shape, or box.

FIGS. 4C and 4 D are optional embodiments of box beams consistent with certain embodiments of the present invention. FIG. 4C illustratively shows two cross-sectional views of C-shaped channel beams 104a and 104b that are essentially the same size and cooperate with one another to form a box beam 410. Here, the two C-shaped channel beams 104a and 104b are off-set and the channel side 205a of the C-shaped channel beam 104a is facing the channel side 205b of the C-shaped channel beam 104b. The two C-shaped channel beams 104a and 104b are essentially disposed in their respective channels 205a and 205b. The C-shaped channel beams 104a and 104b are attached by the upper flanges 202a and 202b, respectively, and the lower flanges 204a and 204b, respectively via the attachment members 402. FIG. 4D illustratively shows two cross-sectional views of a first channel beam 104c that is larger than a second C-shaped channel beam 104d (at least dimensionally along the web height 215), the channel beams 104c and 104d cooperating with one another to form a box beam 450. Here, first C-shaped channel beam 104c receives the second C-shaped channel beam 104d in the first C-shaped channel beam's channel 205c. The channel side 205c of the C-shaped channel beam 104c is facing the channel side 205d of the C-shaped channel beam 104d. The C-shaped channel beams 104c and 104d are attached by the upper flanges 202c and 202d, respectively, and the lower flanges 204c and 204d, respectively via the attachment members 402, thus forming the box shape.

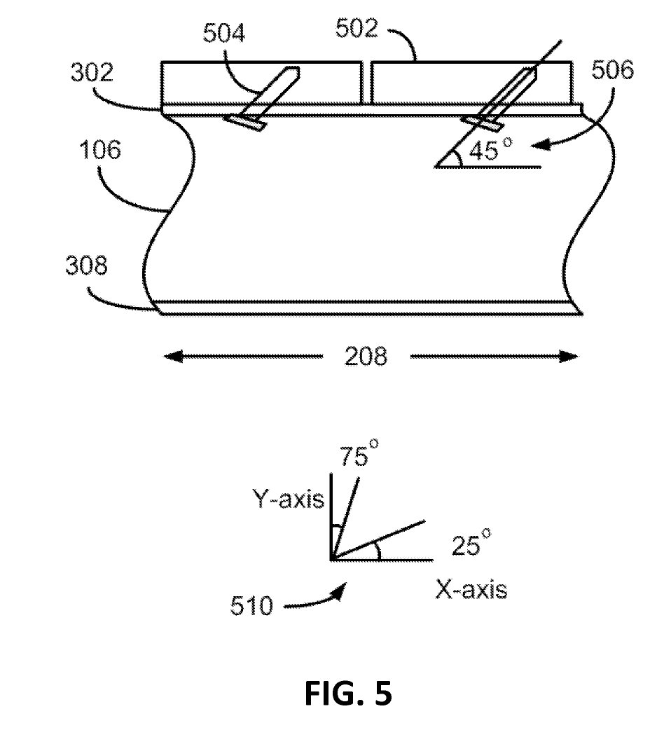

FIG. 5 is an embodiment showing a deck planks 502 attached to a deck joist 106 consistent with embodiments of the present invention. The deck joist 106 is shown along a section of the length 208 with the channel side 335 showing and the returns 320a and 320b not showing. As illustratively shown, the deck planks 502 are fixedly attached to the upper flange 302 of the deck joist 106 via an attachment member 504, such as a ballistic nail, disposed through the upper flange 302 and into the deck plank 502. The attachment members are driven from the inner surface of the upper flange 302 into the deck planks at a 45 degree angle from the inner surface of the upper flange 302, as shown. Also, as illustratively shown, the attachment members 504 do not penetrate the top surfaces of the deck planks 502. In optional embodiments, the attachment members are driven from the inner surface of the upper flange 302 into the deck planks 502 at between 25 degree angle and 75 degree angle from the inner surface of the upper flange 302, as shown by the coordinates 510. In this embodiment, the angularly driven attachment members 504 is the means that increases stability of the attached planks to the outer surface of the upper flange 302 over the disposing attachment members 504 in alternative angles into the planks via the upper flange 302. In yet another optional embodiment, the attachment members 504 are driven into the upper flange 302 at essentially vertically at a 90 degree angle along the Y-axis. As shown in the present embodiment, the planks 502 are not parallel in their respective lengths to the length 208 of the deck joist 106.

It is to be understood that even though numerous characteristics and advantages of various embodiments of the present invention have been set forth in the foregoing description, together with the details of the structure and function of various embodiments of the invention, this disclosure is illustrative only, and changes may be made in detail, especially in matters of structure and arrangement of parts within the principles of the present invention to the full extent indicated by the broad general meaning of the terms in which the appended claims are expressed. For example, similar channel beams of different geometries can be manufactured without departing from the scope and spirit of the present invention. Another example can include using multiple ceramic-based coatings, or the formation of composite ceramic-based coatings, while still maintaining substantially the same functionality without departing from the scope and spirit of the present invention. Finally, although the preferred embodiments described herein are directed to deck frame assemblies, it will be appreciated by those skilled in the art that the teachings of the present invention can be applied to other sub-structural systems, without departing from the spirit and scope of the present invention.

It will be clear that the present invention is well adapted to attain the ends and advantages mentioned as well as those inherent therein. While presently preferred embodiments have been described for purposes of this disclosure, numerous changes may be made which readily suggest themselves to those skilled in the art and which are encompassed in the spirit of the invention disclosed and as defined in the appended claims.

What is claimed is:

1. A channel beam comprising:
steel sheet metal that is bent in a C-shaped cross-section possessing a web with bends forming an upper flange and a lower flange, said channel beam extending in length along said C-shaped cross-section;
a ceramic coating essentially encapsulating said channel beam wherein said sheet metal is essentially encapsulated by said ceramic coating prior to being bent in said C-shaped cross-section;
said sheet metal is between 14 gage and 18 gage steel.

2. The channel beam of claim 1 wherein said upper flange is essentially dimensionally identical to said lower flange.

3. The channel beam of claim 1 wherein said channel beam is adapted to cooperate with a second channel beam to form a box beam that essentially possesses a box-shaped cross-section that extends in said length, said second channel beam possessing a second web, a second upper flange and a second lower flange.

4. The channel beam of claim 3 wherein said second web is larger than said web and said upper flange and said lower flange are disposed between said second upper flange and said second lower flange.

5. The channel beam of claim 3 wherein said first channel beam is fixedly attached to said second channel beam via said flanges.

6. Than channel beam of claim 1 wherein said upper flange possesses an outer surface and an inner surface, said outer surface adapted to support a plank, said plank is adapted to be fixedly attached to said upper flange via nail or screw that penetrates said upper flange, said nail or said screw penetrates said upper flange from said inner surface.

7. The channel beam of claim 6 wherein said nail or said screw penetrates said flange at an angle between 25 degrees and 75 degrees from said inner surface of said top flange.

8. The channel beam of claim 1 wherein said upper flange and said lower flange possess two additional bends at their respective ends to form a U-shaped channel beam.

9. The channel beam of claim 1 wherein said U-shaped channel beam cooperates with said channel beam to form a box beam that essentially possesses a box-shaped cross-section.

10. The channel beam of claim 1 wherein said ceramic coating is heat cured after being applied to said steel sheet metal.

11. The channel beam of claim 1 wherein said upper flange, said lower flange, and said web are essentially comprised of flat surfaces.

12. A channel beam constructed by a method comprising:
providing steel sheet metal possessing a length, a width, and a thickness, wherein said length is dimensionally greater than said width, said width is dimensionally greater than said thickness, said width and said thickness are defined in a plane wherein a cross-section of said sheet metal resides, said thickness is between 14 gage and 18 gage steel;
applying a ceramic coating on said sheet metal to essentially encapsulate said steel sheet metal;
bending said sheet metal after said applying step into a first flange, a second flange, and a web, to form a C-shaped cross-section in said plane, said first flange and said second flange terminate at the edges of said C-shaped cross-section, after said bending step, said sheet metal remains essentially encapsulated by said ceramic coating; and said ceramic coating essentially remaining adhered to said sheet metal after said bending step.

13. The method of claim 12 further providing a U-shaped channel beam that cooperates with said channel beam to form a box beam with a box-shaped cross-section in said plane, said U-shaped channel beam possessing an upper flange bent with and upper return and a lower flange bent with a lower return such that ends of said returns are facing one another.

14. The method of claim 13 wherein said U-shaped channel beam possesses a second web that is shorter than said web associated with said channel beam, disposing said U-shaped channel beam in said second channel beam such that said upper flange and said lower flange are between said first flange and said second flange.

15. The method of claim 13 further comprising fixedly attaching said channel beam with said U-shaped channel beam.

16. The method of claim 12 further comprising fixedly attaching multiple planks to an outer surface of said first flange wherein a plank length of said plank is not parallel to said length.

17. The method of claim 16 wherein said bending step is accomplished via a cold-rolled process.

18. The channel beam of claim 17 wherein said nail or said screw penetrates said first flange at an angle between 25 degrees and 75 degrees from said inner surface of said top flange.

19. A channel beam comprising:
means for bending a steel sheet metal in a channel-shape with a first flange, a second flange and a web member, said steel sheet metal is between 14 gage and 18 gage;
means for coating said steel sheet metal with a ceramic coating to essentially encapsulate said sheet metal prior to bending said steel sheet metal in said channel-shape.

20. The channel beam of claim 19 further comprising means for fixedly attaching planks to an outer surface of said first flange to increase stability of said attached planks.
